(19) United States
(12) Patent Application Publication
(10) Pub. No.: US 2018/0154920 A1
(43) Pub. Date: Jun. 7, 2018

(54) Infant Car seat revision specification

(71) Applicant: Gary Allen, Chicago, IL (US)

(72) Inventor: Gary Allen, Chicago, IL (US)

(21) Appl. No.: 15/279,455

(22) Filed: Dec. 1, 2016

(51) Int. Cl. B62B 7/12; B60N 2/28; B62B 7/06

(52) U.S. Cl. CPC B62B 7/12; B60N 2/2848; B62B 2205/20; B62B 2205/123; B62B 7/06

(57) ABSTRACT

A safe and effective child car seat which can be converted into a safe and effective stroller forming an easier way to carry your child anywhere they need to be strolled only to then convert back into a safe car seat for a ride for a child to your destination. Used for all ages of young children that require car seats. This method is done by lowering the wheels and extending the handles on the car seat when use for a stroll and placing the wheels in the upright position and descending the handles in place when used as a car seat, a perfect safety utility device made in one.

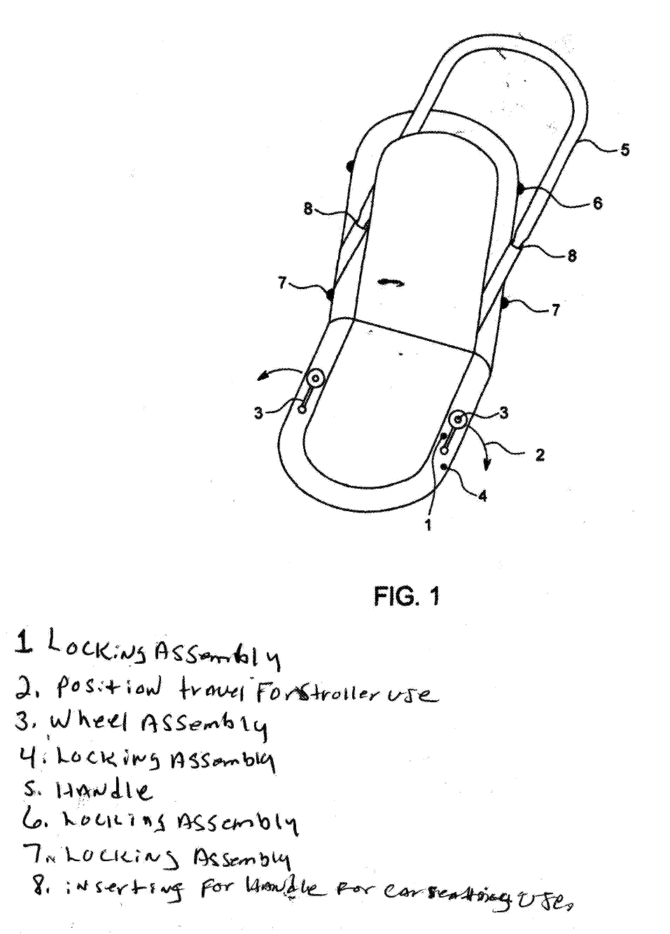

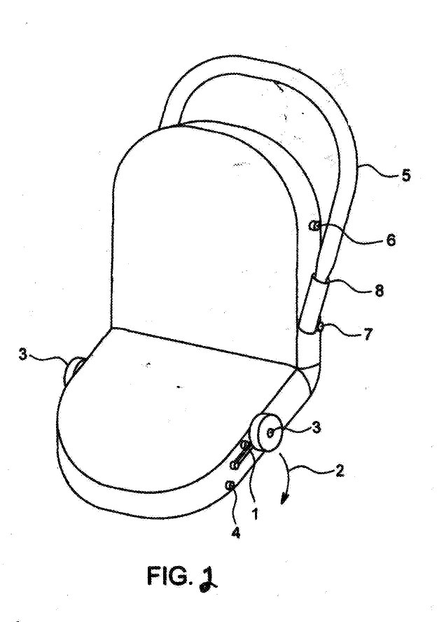

### CROSS-REFERENCE TO RELATED APPLICATIONS

61/004,594, Ser. No. 29/23,446

### STATEMENT REGARDING FEDERALLY SPONSORED RESEARCH OR DEVELOPMENT

NOT APPLICABLE

### THE NAMES OF PARTIES TO A JOINT RESEARCH AGREEMENT

NOT APPLICABLE

### INCORPORATION BY REFERENCE OF MATERIAL SUBMITTED ON A COMPACT DISK OR EFS-WEB

Ser. No. 15/279,455

### STATEMENTS REGARDING PRIOR DISCLOSURES BY THE INVENTOR

SEE CLAIMS AND IMAGE FILE WRAPPER Ser. No. 15/279,455, 61/004,594, Ser. No. 29/293,446

### BACKGROUND OF THE INVENTION—CHILD CAR SEAT

### (1) Field of Invention

UTILITY

### (2) INFORMATION DISCLOSED STATEMENT

APPLICATION Ser. No. 15/279,455 61/004,594 Ser. No. 29/293,446 ALL CLAIMS AND DRAWING ASSOCIATED WITH APPLICATIONS NUMBERS. (SEE IMAGE FILE WRAPPERS)

### BRIEF SUMMARY OF THE INVENTION

THIS INVENTION WAS AN IDEA BY ME GARY ALLEN BECAUSE I SAW HOW HARD IT IS TO CARRY A CHILD AFTER BEING RELEASED FROM A CAR SEAT WHICH MEANS IF I CAN MAKE LIFE EASIER FOR SOULS, I'VE SET OUT TO DO SO, PLEASE GRANT ME THIS PATENT.

### BRIEF DESCRIPTION OF THE SEVERAL VIEWS OF THE DRAWINGS

AS YOU CAN SEE I HAVE ATTACHED AN ORIGINAL DESCRIPTION ON THE DRAWING AND THE REPLACEMENT SHEETS ON EACH DRAWING, YOU CAN CLEARLY SEE I'VE ADDED WHEELS AND THE EXTENDED HANDLES IN AND OUT.

### DETAILED DESCRIPTION OF THE INVENTION

A REVISION

I CLAIM THE WHEELS AND EXTENDED HANDLES AS MY IDEA TO BE DISTRIBUTED ON A CHILDS CAR SEAT AS A UTILITY DEVICE.

1. I claim the ornamental designs of the revision of the child car seat. This idea is a descriptive way for individuals to interchange their child car seats directly into strollers. This can be used in place of the original stroller by simple conversion. After testing for safety issues, this can be a unique and simple way for toddlers to travel. For the stronger individuals they can convert this without removing the child from the seat. I've labeled the precepts and shown you how it will work. Materials for use can be aluminum, Plastics, and Rubber. (SEE PAGES ATTACHED).
